(19) United States
(12) Patent Application Publication
(10) Pub. No.: US 2002/0057438 A1
(43) Pub. Date: May 16, 2002

(54) Method and apparatus for capturing 3D surface and color thereon in real time

(76) Inventor: Derek Edward Decker, Byron, CA (US)

Correspondence Address: Derek Edward Decker, 835 Discovery Bay Blvd., Byron, CA, 94514, US

(21) Appl. No.: 10/007,715

(22) Filed: Nov. 13, 2001

Related U.S. Application Data
(60) Provisional application No. 60/247,248, filed on Nov. 13, 2000.

(51) Int. Cl. G01B 11/24

(52) U.S. Cl. 356/601

(57) ABSTRACT

A method and apparatus for acquiring surface topography. The surface being acquired is illuminated by illumination sources with patterns of light from one optical perspective and the light reflected off the surface is captured by image sensors from one optical perspective that is different than the perspective of the illumination. The images obtained are of the surface with one or more patterns superimposed upon the surface. The surface topography is computed with a processor based upon the patterned image data, the known separation between the illumination sources and the imaging sensors, and knowledge about how the patterns of light are projected from the illumination sources.

### BACKGROUND OF THE INVENTION

1. Field of the Invention

This invention relates to the real-time acquisition of surface topography using non-contact methods by employing a light source and a detector.

2. Related US Application

The present invention claims priority from U.S. Provisional Application No. 60/247,248 filed Nov. 13, 2000 under the same title.

18. Description of the Related Art

There has been a need to accurately model objects for centuries. From the first days of anatomy and botany, people have tried to convey the shapes of things to other people using words, drawings and two-dimensional photographs. Unfortunately, this is often an incomplete and inaccurate description of an object. Often there is the need to have this information in real time, such as monitoring the shape of a heart while it is beating, perhaps while exposed during surgery. Few technologies exist today that can meet the needs of low cost, simplicity, non-contact, high resolution and real time performance. For example, there is a technology where reflecting dots are placed on various surface points on the skin of someone's body for measuring movement of body parts using multiple cameras to track these dots from different perspectives. Such a system could have real time performance as well as low cost but fails by being complex, having very low resolution and requiring contact of reflectors to the surface (not a good technology for the heart application mentioned above).

By capturing the true surface shape, without making physical contact, and automatically having that topology entered into a computer for easy rendering of the model in real time, one can obtain better knowledge about the objects being investigated. One can also imagine real-time manipulation of the model. For example, when an object moves outside of a predetermined boundary or fails to follow a predetermined motion, the color of the modeled surface is changed and an audible sound is triggered. Going back to the heart example, such real time modification of the model could help doctors to detect and visualize abnormal heart function.

In reviewing the prior art, many patents require two or more light sources or two or more cameras or detectors in order to extract surface information. The additional sources and detectors used by others in this type of system are not needed for the invention in this application. For example, U.S. Pat. No. 5,691,815 by Huber, et al. teaches the need for two light sources in perpendicular slit arrangements, each illuminating a slice of the surface at different angles with respect to each other. Such an additional complication is not needed by the invention in this application, which only uses one source. Also, Huber's method only determines the position of one point rather than for all points simultaneously in one image as is done in the present invention.

U.S. Pat. No. 6,141,105 by Yahashi, et al. does function with a single source and imaging detector. However, it requires angle scanning a slit source with time and synchronously capturing multiple images in order to acquire the surface data. Disadvantages include getting incorrect data on surfaces that are moving which change shape during the time interval required to take multiple images. U.S. Pat. No. 6,233,049 by Kondo, et al. and U.S. Pat. No. 6,094,270 by Uomori, et al. both suffer from the same problem of scanning a slit illumination. Both also suffer from slow speed because they must capture and process, as many images as there are lines of resolution (which could be thousands of lines in a megapixel resolution system).

U.S. Pat. No. 5,969,820 by Yoshii, et al. uses oblique illumination of target patterns on semiconductor wafers to get the proper height of the flat surface before exposing its photoresist coating on the surface to a two dimensional optical pattern for circuit fabrication applications. The intent of this patent is not to determine surface shape of irregular surfaces and in fact would fail to do so due to shadowing that occurs from oblique angle illumination. It also fails to collect more than one surface height, relying on the knowledge they are working with a flat surface.

U.S. Pat. No. 6,128,585 by Greer describes a system that requires a reference target He goes on to describe this reference target as being in a tetrahedral shape and having LEDs at the vertices that blink at different rates so they can be identified in a computerized vision system. Greer's patent and claims are written with the purpose of positioning a feature sensor and not with determining surface topography. Moreover, the requirement of a reference target with blinking vertices adds complexity and cost and slows down the time it takes the computerized vision system to calibrate and operate.

U.S. Pat. No. 4,541,721 by Robert Dewar mentions using a single line of collimated light incident across a gap between surfaces that one is trying to measure and control for manufacturing purposes. The need for collimated light, rather than a divergent light source, suffers from several limitations including the greater cost and complexity as well as safety concerns of using a laser source and having to arrange optics which must be at least as large as the collimated light beam. Additionally, gaps imply shadows, which are particularly troublesome for acquiring surface topography due to a loss of reflected light. Furthermore, trying to use Dewar's system for topography across a surface with a thousand lines of resolution would require a thousand images be captured and processed while the present invention can do it all in one step.

A method described by inventor Shin Yee Lu (in U.S. Pat. No. 5,852,672) employs two cameras and a light projector which all must be precisely aligned and calibrated. FIG. 1 is an illustration of the top view of Lu's system 10 (which is roughly equivalent to Lu's FIG. 9 in U.S. Pat. No. 5,852,672). The camera sensors, CCDs 12, can be thought to image through pinholes 14. Regions in object space 16 image through pinhole 14 to image space 18 where light from a particular object point follows a path 20 through the pinhole 14 to a pixel on CCD 12. There exists an overlap region 22 of the two object spaces 16 defined by each camera. By having the object 24 viewed by both cameras in the overlap region 22, it becomes possible for a common point to be found in each CCD 12. Finding a common point in some regions will not be possible when the slope of the surface is sufficiently steep to create shadowing which prevents one or both cameras from seeing a particular spot A projector 26 between the CCD's 12 projects a vertical array of lines 28 onto the object 24, and through software intelligence in a computer system (not shown), tries to identify common points on the object 24 from images captured by the CCDs 12. If a common point is determined, triangulation can be performed by using the intersection of the two imaging lines 20 emanating from the common point on the object 24.

Lu makes use of triangulating two intersecting imaging lines (one from each camera system) by guessing at the intersection point on the surface with help from a projection of vertical light and dark lines and intelligent software. The light and dark pattern (such as using a Ronchi ruling) is imaged onto the surface. The shadows obscure information that is lost which decreases the resolution one can obtain.

While Lu does explain how one can obtain sub-pixel accuracy, it comes at a cost of reduced resolution. For example, in the case of Lu's projection scheme, assume that there are approximately three pixels in shadow and three pixels in light for a period of light and dark regions imaged onto CCD pixels. See illustration 30 in FIG. 2a where dark regions 32 fall upon camera picture elements, pixels 34. There are approximately six pixels per period and two edges per period in this example. FIG. 2b shows in illustration 40 how two adjacent pixels will have similar values (such as the dark pixels 2, 3 and 8, 9 and light pixels 5, 6) but, in general, at an edge (pixels 1, 4, 7, and 10) will be some values between light and dark established by where the edge of light falls within these pixels. The pixel will integrate all of the light incident upon it resulting in an average intensity value. Dark region 38 and light region 40 illustrate the minimum and maximum values while gray region 42 and a darker gray region 44 in illustration 40 convey that an edge (of the light and dark pattern) falls within those pixels. Suffice it to say, interpolation and other numerical techniques can be applied to the pixel intensity values (see FIG. 2c) in order to obtain knowledge about the edge location that is more precise than the resolution of the pixel array. In other words, the edge can be determined to be located within a fraction of a pixel. But what does this say about the number of points in a resultant three dimensional mesh? It says that only one in three pixels are used to define positions. When compared to the present invention, which uses every pixel, the number of points used by Lu is reduced by a factor of three and a great amount of information is thereby lost. It also turns out that the method for obtaining sub-pixel accuracy can still be applied to this invention so there is no trade off in accuracy, there is only a significant 3× gain in resolution. Sub-pixel accuracy is obtained in this invention by interpolation and other numerical techniques being applied to detected colors along any row of pixels being analyzed.

### SUMMARY OF THE INVENTION

This invention describes a method and an apparatus for acquiring surface topography, which the dictionary defines as the surface configuration of anything. The surface being acquired is illuminated with patterns of light from one optical perspective and the light reflected off the surface is captured by image sensors from one optical perspective that is different than the perspective of the illumination. The images obtained are of the surface with one or more patterns superimposed upon the surface. The surface topography is computed based upon the patterned image data, the known separation between the illumination sources and the imaging sensors, and knowledge about how the patterns of light are projected from the illumination sources. This method can be carried out by the following apparatus. Illumination sources emit patterns of light onto the surface through one optical perspective. Image sensors image the surface through one optical perspective which is different from the optical perspective of the illumination sources. A processor is coupled to the illumination sources and the imaging sensors. The processor computes the surface topography.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is prior art and represents a top view of the system by Lu in which two camera imaging systems and the projection of lines on a surface can be used to try and determine surface topology.

FIG. 2a, FIG. 2b and FIG. 2c depict how Lu's projection of black and white lines, when imaged onto a row of CCD pixels, results in pixel integrated gray levels that can be used to obtain sub-pixel accuracy of line edge location.

FIG. 3a, FIG. 3b, FIG. 3c, FIG. 3d and FIG. 3e show perspective views of the way in which triangulation and coordinates can be obtained.

FIG. 4 is a top view of the preferred embodiment of the invention in which an object is illuminated by light (which varies in color), is imaged by a color camera, and computer processing of the image results in a 3D surface model displayed on the computer screen.

FIG. 5 is an illustration that shows the three flat cut away surfaces on the inside of the spherical section in a color space with red, green and blue coordinate axes.

FIG. 6 is an illustration that shows a path (on the curved surface of the normalized color sphere) which is starting at red and spiraling in to end up at white.

FIG. 7 is the image formed by the intersection of a rainbow light projector and a white piece of paper.

FIG. 8 is the image formed by the intersection of a rainbow light projector and a white ceramic object in the shape of a kitten holding a ball.

FIG. 9a is a bar chart indicating that given white light illumination (equal intensities of red, green and blue) on the surface, reflections making into the camera off a colored surface (such as a green iris) result in half of the red light making it into a particular camera pixel while all of the green made it and only a quarter of the blue made it in.

FIG. 9b is a bar chart indicating that for an unknown projector color illumination, half of the red made it into the camera pixel while none of the green made it and only a quarter of the blue made it in.

FIG. 9c is a bar chart illustrating that we doubled the red light in FIG. 9b (by dividing out the ½ red response of the surface imaged by that pixel) and we quadrupled the blue light in FIG. 9b (by dividing out the ¼ blue response of the surface imaged by that pixel) which tells us that the color incident on the surface (before it was changed by the surface) was a light purple with equal amounts of blue and red.

### DETAILED DESCRIPTION OF THE INVENTION

The following description is provided to enable any person skilled in the art to make and use the invention and sets forth the best modes presently contemplated by the inventor of carrying out the invention. Various modifications, however, will remain readily apparent to those skilled in the art, since the generic principles of the present invention have been defined herein.

This invention can be used for acquiring surface topography in real time. It makes use of an illumination system to project patterns of light on a surface from one perspective and simultaneously acquires images of that surface from a slightly different perspective. The images obtained of the surface have one or more patterns superimposed upon them. One way in which to utilize more than one illumination source with the same perspective view is to make use of beam splitters within the illumination subsystem. One way in which to utilize more than one imaging sensor with the same perspective view is also to make use of beam splitters within the imaging subsystem. A computing device is used to detect the distortions of these patterns and compute the surface topography.

This invention acquires all the surface data in a single snapshot, eliminating errors associated with scanning systems and objects which change their shape or position with time. The snapshot time interval is limited only by a combination of shutter speed and/or a flash of illumination, so long as sufficient numbers of photons interact with the imaging detector to give a good signal. This can presumably be on the order of billionths of a second (or less) if nanosecond (or shorter) laser pulses are employed.

In the preferred embodiment, this invention uses only one color light source and one color camera to determine the topography of surfaces in real time. This makes for a simple and inexpensive system. Unlike other systems, this invention can determine the x, y and z positions of every surface point imaged by a pixel of the camera with only one color image. An equivalent position of a point on the surface can be represented in spherical coordinates of radius from the origin, and angles theta and phi.

Once these positions are known in the computer they can be displayed as a contour map, shaded surface, wire mesh or interactively moveable object as might be done in any number of computer aided design software packages.

All triangulation is accomplished through knowledge of the paths each ray of light travels from an illumination source point to a point at the camera image. Color coding is used to help make each ray easily identifiable by the detector and the image processing software in the computer. Among the many advantages of this invention are simplicity, reduced cost of hardware and rapid operation. Real time is meant to infer that surface data can be captured at video rates or rates in which the human eye does not detect individual frames, in other words, seeing a continuous motion. This is very important for applications including video conferencing and virtual presence as well as surgery accomplished over the Internet using robotics and real time visual feedback. This invention could actually operate much faster, limited only by the time it takes to capture and process the image. For some experiments, the data could be collected with film, CCDs or other methods and the processing (often the longer task) could be done afterwards to study such things as cell division and shape evolution of shocked surfaces.

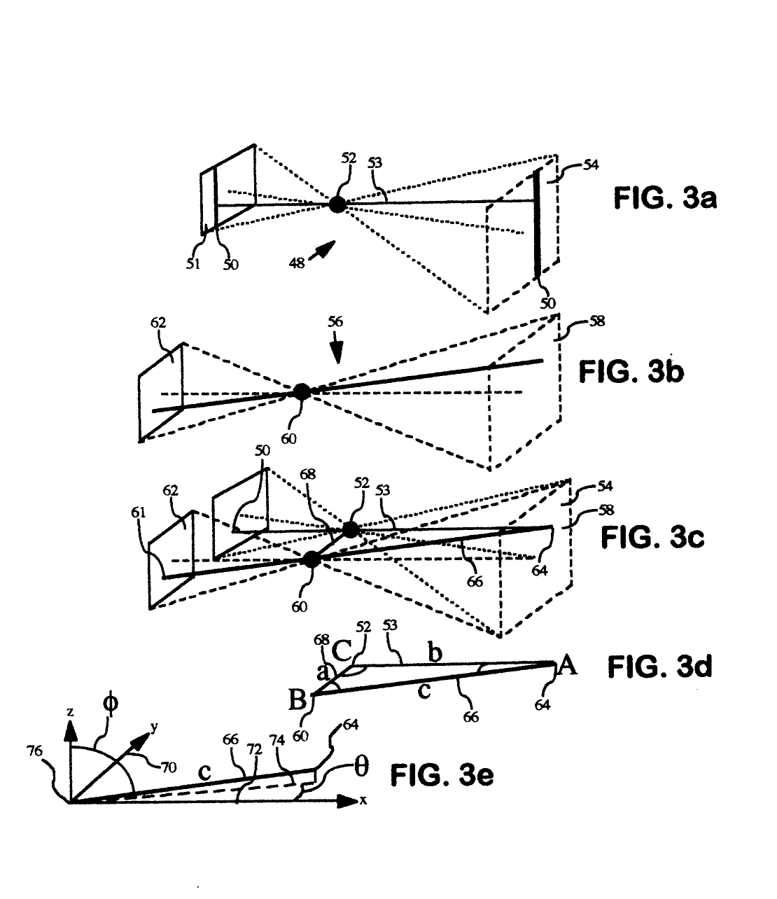

The illumination system 48 in FIG. 3a projects a vertical array of planes of light, each plane differing in color and angle. This could be accomplished with a back illuminated transparency (such as a 35 mm slide in a slide projector) or by generating a rainbow using a prism or grating to separate the colors (in angle) from a white light source. In either case, each system can maintain intensity over the surface being inspected but vary in color along the horizontal direction. The intersection of this projected beam and a flat white surface would simply be imaged by the color camera as an array of columns (each having a unique color), each color identified by their relative ratio of red, green and blue light. FIG. 3a illustrates one color 50 of the spectrum being projected from a transparency 51 on the left through a pinhole 52 along projection ray 53 to a region 54.

FIG. 3b illustrates an imaging system 56 comprising object space region 58 imaged through pinhole 60 until the light arrives on an imaging detector 62, such as a CCD. FIG. 3c shows the combination of the systems in FIG. 3a and FIG. 3b with overlap of regions 54 and 58 of those figures, respectively. Shown is colored light 50 passing through projector pinhole 52 along projection ray 53 and on to the object surface point 64 which reflects off the surface and follows imaging path 66 through camera pinhole 60 to a pixel 61 of CCD 62.

FIG. 3d shows a triangle comprised of segment “c” of the imaging path 66, segment “b” of the projection ray 53 and a line 68 connecting the pinholes and labeled “a” . Opposite these sides are their respective angles A (at object point 64), B (at camera pinhole 60) and C (at projector pinhole 52). We can let “a” coincide with the y axis 70 in FIG. 3e. Given knowledge about “a” and the geometrical location of pinholes relative to the CCD 62 and transparency 51, we can determine angle B (from the relationship between the pixel location 61 and camera pinhole 60) and angle C from the color (determined by the camera), angles of imaging path 66 and prior knowledge of how color is projected as a function of angle through projector pinhole 52. Angle A=180° −B−C because the sum of angles in any triangle is always 180°. The Law of Sines tells us a/SinA=b/SinB=c/SinC. We can now solve for the two unkowns b=SinB(a/SinA) and c=SinC(a/SinA).

The relationship between the camera pinhole 60 and pixel location on CCD 62 gives us the angles theta and phi as shown in FIG. 3e. The radius is simply the length c. We now have all we need to identify the position of object point 64 in three dimensional space. Theta is defined as the angle in the x and y plane as measured from the x axis 72 to the projection 74 on the x and y plane of the imaging line 66 connecting the origin 76 to the object point 64. Phi is the angle measured from the z axis to that line segment “c”. Conversion to x, y, z or other coordinates is trivial at this point.

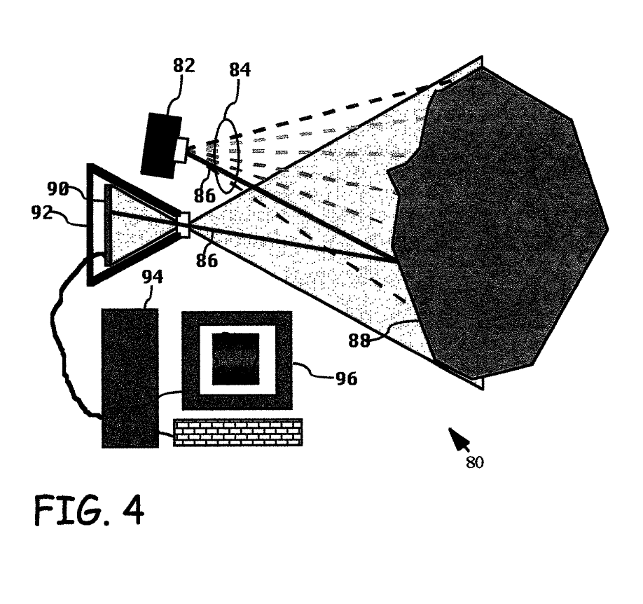

FIG. 4 is a top view of the preferred embodiment 80. The illumination system 82 projects a vertical (out of the paper) array of planes of light 84, each plane differing in color and angle. One color 86 reflects off surface 88 and is imaged on CCD 90. The camera 92 transfers the color image to a computer 94 where it is processed into three-dimensional data and displayed on monitor 96.

The color camera 92 identifies these colored planes by their relative ratio of red, green and blue light. An advantage of using color to uniquely identify planes of light is that it is independent of intensity and therefor has no requirement for intensity calibration between the projector and camera. In standard cameras and frame capture electronics, each pixel is assigned a 24-bit number to determine its color and intensity. These 24 bits represent 8 bits for red, 8 for green and 8 for blue. Eight bit numbers in integer format range from 0 to 255 (the equivalent of 256 equally spaced values). For most purposes we can define pixel values as a triplet of the form (Red,Green,Blue) where (255, 0, 0) is red, (0, 255, 0) is green and (0, 0, 255) is blue.

Other pixel representations exist, such as (Cyan, Yellow, Magenta, blacK) and (Intenisty, Hue, Saturation), but the (R, G, B) format will suffice for the moment. In particular, it will be important to define color as independent from intensity. For example, since equal amounts of red and blue makes a purple color, we define (200, 0, 200) and (5, 0, 5) to be the same color but of different intensity. The higher numbers (or counts in CCD jargon) indicate more intense light (higher numbers of photons) were incident on the pixels because they generated more electrons in the CCD pixel wells that when shifted out of the image detector were digitized to yield a bigger number. Thus, one could say (5, 0, 5) is a darker version of the light purple color (200, 0, 200).

Unless we have well known surfaces under inspection, like parts coming off an assembly line, it is probable that reflectivity will vary across the surface being analyzed. In fact, not only can there be absorption in the surface and along the optical path, but the surface angles and surface's specular quality will alter how much light gets back into the imaging system (because scattering and vignetting occurs). Additionally, reflected colors can be changed by colored surfaces (reflecting more of one color and absorbing more of another color) and secondary reflections (such as red reflections off the side of a nose making a blue illuminated cheek appear more purple than it would be without the secondary reflection). To improve results, we can take a white light picture and divide the color efficiencies into the image taken with the special color illumination system. This is important for objects with varying reflectivity along the surface (like red lips and green eyes from a face). It has the added advantage that one may map the white illuminated color image back onto the 3D surface, giving you 4D information (original surface color being the fourth dimension).

Strictly speaking, color does not qualify as a fourth dimension in the same way space does. Dimensions in space (x, y, and z) each extend from minus infinity to plus infinity. Color can be characterised in many ways but for our purposes we will either use red, green and blue (R, G, B) or cyan, yellow, magenta and black (C, Y, M, K). Each of those subdimensions varies from zero to a maximum, which our sensors (camera, film, scanner, densitometer, profilometer, etc.) can detect.

If the projector is a computer controllable device, such as a projection video display or spatial light modulator, one can also use the white light image to control the projector intensities and color to produce a projected illumination pattern that will optimize signals at the detector. This can be accomplished by computer processing the white light illuminated image. Using that information one can brighten the colored projection image in specific locations where it was dark on the white light image due to absorptive pigments, scattering surfaces or shiny surfaces that slope away from near normal incidence (and thus little light is reflected into the camera optics, a vignetting effect).

Up to this point in this application, the imaging optics of the projector and camera have been described to simply comprise a pinhole. In reality, lenses are more likely to be used, given that they are able to transmit more light and image more effectively.

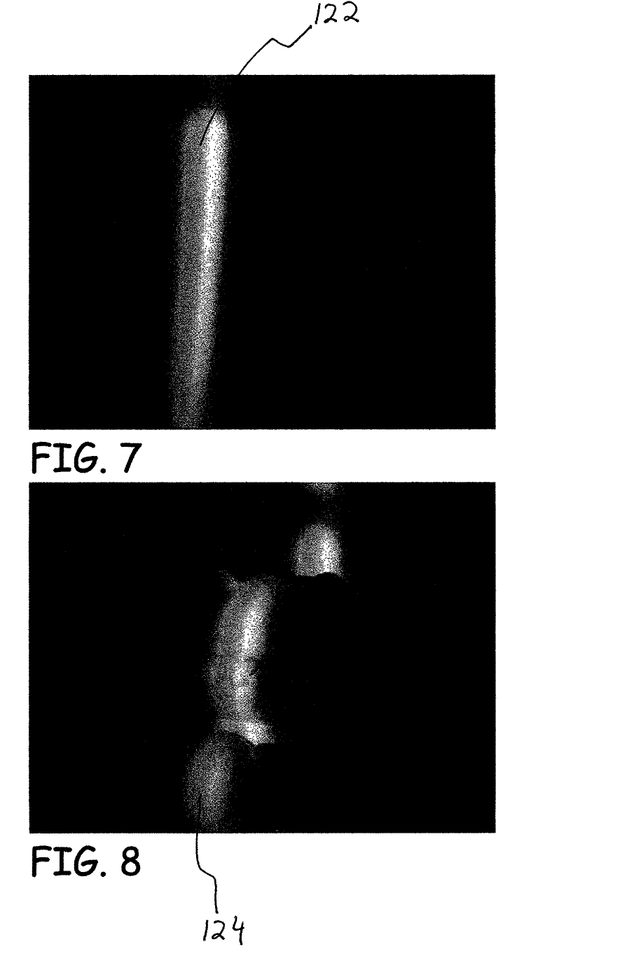

The pattern of projector light need not be the rainbow shown in FIG. 7. And, projected lines in the context of this application need not be straight lines, rather they are permitted to be curved lines so long as they do not cross any row more than once. One could also have the planes of light be projected horizontal or along another direction instead of vertical. One only need to displace the optical axis of the imaging system along a path that is other than along that same direction. Displacement of the camera along the same direction as the angle of the light planes would eliminate the perceived shift in source rays because these rays would be stretched and compressed along the same direction as those rays of the same color and thus the computer would not be able to tell where the ray movement occurred. For curved planes and lines, the displacement must be along any path other than along the direction of any tangent of the curved lines.

To obtain sub-pixel resolution as well as uniquely coded light planes, one should consider using a continuous range of changing color projected onto the surface from left to right. By knowing the path in color space is smooth and continuous, one can perform interpolation and other numerical methods. To visualize color space, let the three colors (Red, Green and Blue) represent independent axes (which are perpendicular to each other like the edges on a cube). Let one corner of a cube be the origin of the color space and as you travel along either of three adjacent edges (the three color axes), the values go from 0 to 255. The farthest corner from the origin has the value (255, 255, 255) and represents white. Traveling back to the origin along the cube diagonal, each component decreases uniformly to shades of gray and eventually black at the origin.

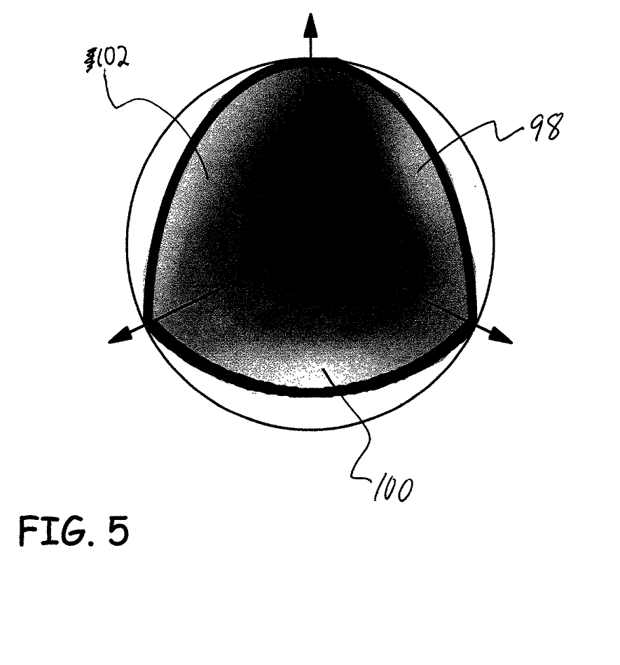

In order to compare colors, we do a normalization of the color vector in color space by dividing each component by the length of the vector. Now imagine a sphere of unit radius (radius equal to one). Since the normalized color vectors all have a length of one, each vector extends from the origin to the surface of the unit sphere. In other words, convert from cartesian to polar coordinates and concern yourself only with the angles. What was a three element color (R, G, B) is now a two angle color (alpha and gamma). The color space can now be visualized as an eighth of a sphere because the initial components (R, G, B) were always positive in value. Just place the sphere origin at the origin previously defined for our color space cube and you'll see the intersection is a one-eighth section of the sphere. FIG. 5 shows the three flat surfaces 98, 100 and 102 on the inside of the sphere section.

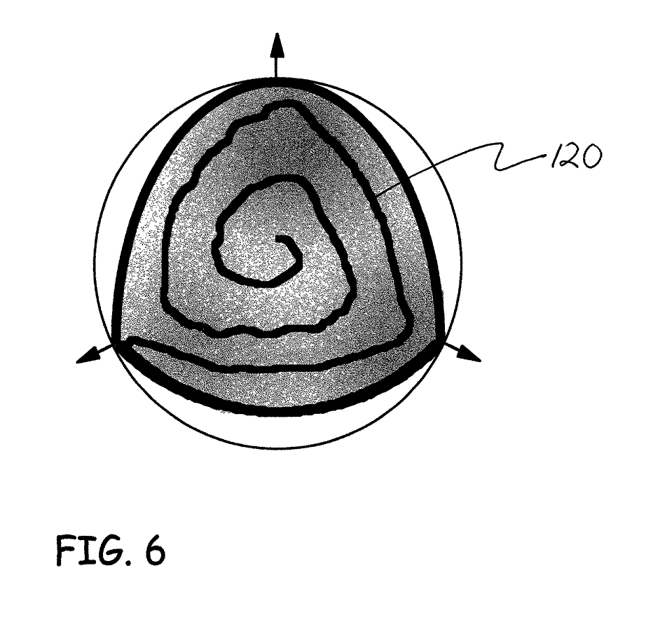

To select an improved rainbow for uniqueness and sub-pixel accuracy, one merely need travel along the color space (on the curved surface of the one-eighth section of the color sphere) in the following way. There should be one beginning, one end, no crossings, and sufficient space between paths such that experimental errors don't cause an interpretation problem. FIG. 6 shows such a path 120 starting at red and spiraling in to end up at white. Other improvements might include minimizing curvature in this path, especially where there is a need for fewer errors, perhaps in the middle of your image. One can also improve data analysis by maximizing the rate of color change per unit angle from the projector in places of importance, such as the middle section.

A prototype system has been built and tested. Positive results exist confirming the technique works as predicted. A rainbow projector was built using a slide projector and a prism. FIG. 7 shows the rainbow 122 incident on a flat piece of paper and you see columns of common color ranging from blue on the left to red on the right. The light comes in from the left, which means the camera is horizontally displaced to the right of the projector. In FIG. 8 notice the ball 124 held by the kitten. The yellow column down the middle gets bowed to the left (concave right) to make a “(” shape of yellow on the ball. The horizontal row of pixels (imaged in the middle of the ball) sees that colors red through yellow are stretched out while colors yellow through blue are compressed. Software that processes these images will yield surface height information. The amount of horizontal movement of a color is indicative of the surface height. In this configuration a greater shift to the left signifies that the surface is closer to the camera. By using images of the light projected on one or more flat surfaces, one can reduce the calculations needed for surface height by simply multiplying the measured horizontal shift in pixels of a color by a pre-calibrated table of values (having units of length divided by pixel shift).

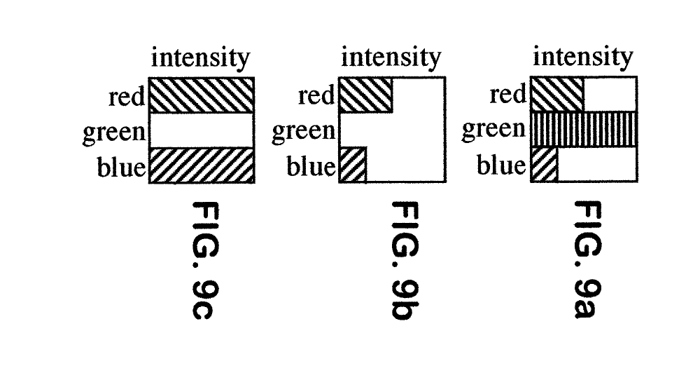

Using a white light image of the surface also helps to counter problems associated with surfaces that are colored and have varying color across their surface (like a face with green eyes and red lips). For example, consider a pixel imaging the green iris on someone's eye. FIG. 9a is a graph indicating that given white light illumination (equal intensities of red, green and blue) on the surface, half of the red made it into the camera pixel while all of the green made it and only a quarter of the blue made it in. FIG. 9b is a graph indicating that for an unknown projector color illumination, half of the red made it into the camera pixel while none of the green made it and only a quarter of the blue made it in. FIG. 9c illustrates that we doubled the red light in FIG. 9b (by dividing out the ½ red transmission response of the surface imaged by that pixel) and we quadrupled the blue light in FIG. 9b (by dividing out the ¼ blue transmission response of the surface imaged by that pixel). This tells us that the color incident on the surface (before it was changed by the surface) was a light purple with equal amounts of blue and red. The white light color response which is divided into the data (from the projection of colored lines), takes into account all of the optical effects including such things as absorption, scattering, fluorescense and secondary reflections.

To obtain higher spatial resolutions, a number of digital cameras are becoming available with millions of pixels. Exposing film, which can later be scanned, is another way to increase the resolution. If the object is stationary, then a line scan digital camera can acquire tens of millions of pixels. Color depth resolution can also be improved with scientific grade CCDs that have more bits per pixel and of course, film and scanners can obtain better resolution than eight bits per color.

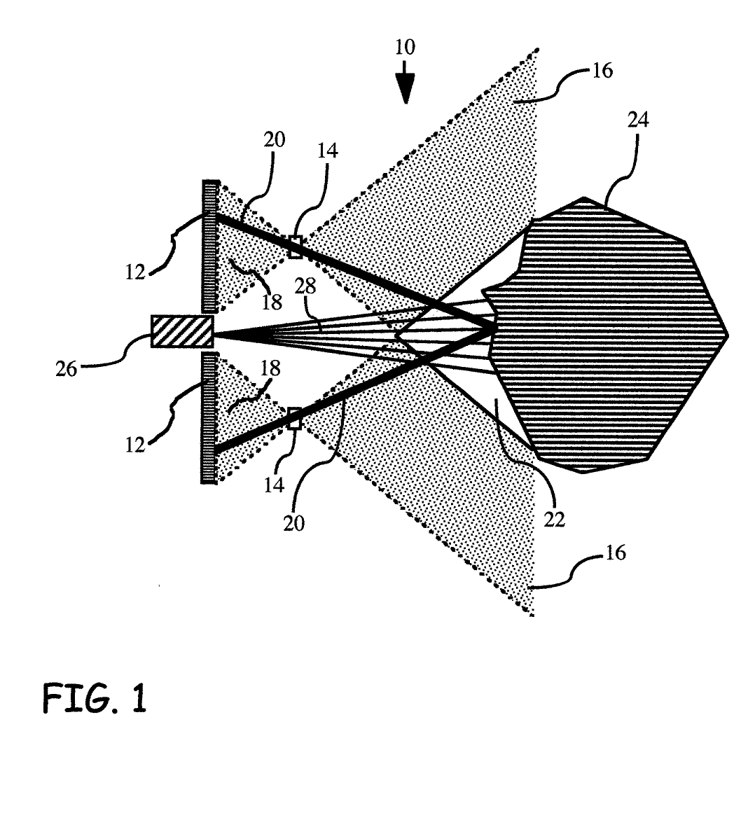

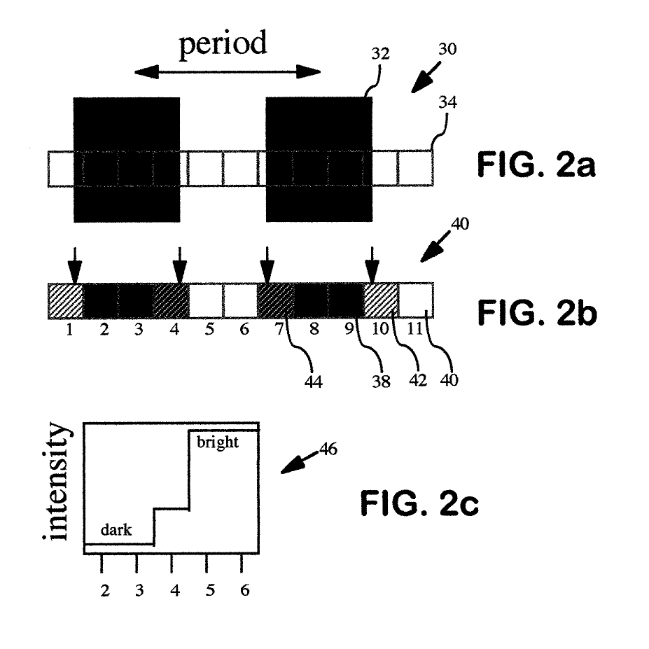

Lu (U.S. Pat. No. 5,852,672)makes use of triangulating two intersecting imaging lines (one from each camera system) by guessing at the intersection point on the surface with help from a projection of vertical light and dark lines and intelligent software. See FIG. 1. Instead of triangulating by intersecting two lines (one from each camera system) and guessing at the intersection point from vertical line projection and intelligent software, the present invention would instead triangulate by intersecting one line (determined by one camera) with a plane of light (from a special illumination system). This will substantially reduce the cost and complexity and will greatly simplify the analysis which will also yield more accurate information since there is no guessing required because each plane is individually distinguishable by its color. Also, the shadows obscure information which decreases the resolution one can obtain in Lu's system. An advantage of the present invention, is that every point on the surface is illuminated and triangulated. The present invention attempts to maintains maximum brightness at every point in the image to improve signal to noise ratios and better identify colors which uniquely indicate which plane of light is being used for triangulation

In another embodiment, an improved arrangement of colors may not necessarily have similar colors being adjacent to one another. The more distinct a neighboring color is, the more easily it will be differentiated from neighboring pixels. One could imagine having a sharp transition for at least one of the primary colors (blue, no blue, blue, no blue, etc.) at the highest resolution predicted for the system. A continuous illumination of color can still be maintained so as to project a relatively flat intensity across the object. In this way, the two pupils of someone's face would be the same diameter. In the patent by Lu, a Ronchii ruling projects alternating bars of light and darkness. This could cause pupils to be opened differently if illuminated unequally and can cause discomfort in the eyes and headaches for the viewer. Selecting the best arrangement of colors for the special illuminator will require additional theory and experiments which focus on the individual applications that will certainly have different requirements for resolution, comfort and accuracy.

In another embodiment, one can also imagine use of infrared sources (possibly laser sources since they have a long range and large depth of focus). Covert battlefield identification of objects as well as biometric identification of people in airports or security environments can also be implemented so as not to let anyone see that a pattern of invisible light is incident upon someone's face or body. So far in this application, a method has been described whereby a computer identifies the individual planes of light via color. One could use two, three or more wavelengths (colors) in the infrared or ultraviolet as long as the sensor is appropriately filtered.

Most color camera sensors actually have three times as many pixels as they quote because each picture element is really comprised of three silicon detector wells with a red filter on one, a green filter atop the second and a blue filter covering the third. Some cameras use three CCD chips, appropriately filtered and setup optically (usually with beam splitters) to receive the same image from the same perspective.

In another embodiment, employing single color illumination (such as a 1064 nm wavelength infrared laser) can be done but it likely requires more computation and would likely have to trade off resolution. The computer still needs to uniquely identify each plane of light from the projection source still using just one camera. A uniquely identifiable plane of light can be coded by sub-planes in which each sub-plane has an intensity variation relative to its neighbor. For example, let the value of four adjacent sub-planes be 0, 4, 2 and 9. That plane is now coded with identifier 42 where the values 0 and 9 provide a local reference to calculate the ratios of intensities. We depend on our surface having low spatial frequencies in its surface reflectivity. For example, assume a mole or freckle on the skin is on the order of one millimeter. In that case, you'd want a higher spatial frequency encoding such as lines with widths of 0.25 millimeters or smaller. That is not unreasonable given that 2000 pixels spread across a 200 millimeters wide face results in a resolution of 0.1 millimeters. Also, at certain wavelengths, skin pigment variations in reflectivity is greatly reduced which plays to our advantage.

Assume our infrared application can afford an off the shelf 16-bit scientific grade CCD camera system with 2,000 by 2,000 pixels. These have been available for many years. Instead of 256 levels we now have 65,536 levels. We can now employ something akin to watermarking where slight variations are put on the surface, which are sufficiently different that our camera and computer can extract them. Returning to our 0 4 2 9 example above, the values (or CCD counts) detected by our system might be 50,000 50,040 50,020 and 50,090. This appears to the casual observer to be uniform illumination, varying by less than 0.2%. You might think we've lost resolution in this process because four pixels (or more) are used to identify a light plane. However, given we know the identity of a group, we also know the positions of the sub-planes and full resolution is restored!

In another embodiment, intensity coding can be performed in different polarization modes, instead of space (sub-planes). As a simple example, the vertical polarization and horizontal polarization of a single illumination beam may have two independent patterns of varying intensity. For instantaneous capture of both images, two cameras can be used (one filtered for vertical polarization and the other of horizontal polarization). For one camera, two sequential exposures can be taken while a filter system (such as a polarizer) is altered between states that allow light with vertical polarization to get to the camera and then for the next exposure, transmission of horizontal polarization.

In another embodiment, one could also envision replacing color-coding with polarization coding. Polarization can be decomposed into independent values of ellipticity (between linear and circular) and the angle of the polarization axis (0° to 180°). However, the surface under interrogation can unpredictably alter the polarization and it usually requires analysis of several images filtered for different polarization states to obtain the polarization ellipticity and angle. Advantages include single wavelength operation and no time interval if multiple cameras are used to acquire all the data at once.

In another embodiment, intensity coding can be performed in time instead of space using multiple images (either using sequential exposures of the one camera or gating multiple cameras with the same perspective). This adds synchronization requirements, complexity and cost to the projection system as well as the image sensing system.

Applications of this technology include real-time (video frame rate) 3D capture of people's faces for video conferencing (tilting can be performed to simulate eye to eye contact which is not present in today's systems), virtual meetings, telemedicine (getting a 3D view for performing operations or analysis over a network like the internet) and biometrics (for identifying suspected criminals or terrorists or for security authorization access to places or computer terminals, etc.). One can also imagine exaggerating features for a caricature-like interaction or even manipulation of cartoon-like cyber creatures. This technology could also be used in reconstructive surgery and to improve auto focus mechanisms.

More interactive experiences such as gaming is possible when the whole body is scanned in and adventures in cyber space occurs with multiple players. One can also use it in various ways to learn dance, martial arts and sports. One example is to see (on a screen but preferably with cyber goggles) your body position as it contrasts with an ideal position as instructed by a dance teacher, Tai Chi master or boxing coach. You could imagine seeing a wire frame outline where your arms or legs should be. Or, transducers in a suit could be used to feel vibrations when you are not properly positioned. This brings us the opportunity for blind people to learn movements without the expense of paying a person to guide them. Of coarse, suit fitting, modeling and fantasy adventures in cyber space all become possible for many more people because this technology is very inexpensive. The field of sports medicine, chiropractic and physical therapy can all make use of better diagnostics such as is provided by this invention. Body growth, posture and gait can also be analyzed for biometrics identification, health and social reasons (including etiquette). Such a system might notice the growth of a cancerous lump sooner than a trained specialist because it can precisely compare body shape over time and detect otherwise imperceptible changes.

Monitoring the growth of plants, animals and even cells and smaller organisms can yield import clues as to how things grow and evolve. In applications where one wishes to study shape evolution over time scales that are too short for available computers to keep up with, one may capture the images with any form of high speed photography (or other image capture) and process the images later and display the surface evolution in a three dimensional animation.

The entertainment industry, manufacturing, government, and media companies (and likely others) would enjoy a cheap tool such as described in this invention to digitize clay models, scan machine parts, analyze weapon fragments, and scan in objects of just about anything for checking dimensional tolerances, aesthetic appeal, forensics and advertising. This system could assist in the inspection and assembly of parts by robots or remote control in an assembly line or other automated manufacturing environment. Telepresence in hazardous environments (biohazard, radioactivity, military, etc.) is another candidate for this technology.

Real-time performance can be traded off for high resolution by replacing the real-time camera with either a slower readout but higher pixel count CCD (linear or 2D array) or by going to film (which is subsequently developed and scanned). When coupled to a desktop manufacturing process (like UV polymerization of plastic parts using 3D CAD models) a 3D replicator (or 3D xerox machine) is possible in which this 3D scanner provides the desktop manufacturing system with the data it needs about the object it will duplicate. A single image gives a surface topography as seen from only one view. To obtain the objects entire surface (front, back, top, bottom and sides), several images (each from a different perspective) would be processed to yield a sufficient number of surfaces that are subsequently stitched together mathematically. To get the different perspective views, either the object can be rotated or the system can be moved around the object or some combination of both being moved is required unless multiple surface capture systems are positioned around the object.

One can also increase the resolution by simply increasing the camera magnification. This acquires a smaller portion of the surface and stitching may be needed to obtain large surfaces with high resolution. Line scan cameras can vary their resolution along their scan direction. And, imaging sensors that use two-dimensional scanning can vary their resolution along both of their scan directions. It may be necessary to change the angular spread of colors from the projector in order to match any magnification change in the camera.

CCD cameras are very inexpensive and they are popping up on computers everywhere. If you already have a camera (such as a camcorder), which interfaces to a computer, then all that is required is the illumination system and software. The illumination system can be as simple as a color slide that is imaged onto your object. More elaborate systems include using lasers or laser diodes. As long as the scene is darkened relative to the illumination of the projector or the color sources are sufficiently narrow in their wavelength spectrum and narrow band filters block most of the ambient light from entering the camera, then low power lights sources can be used. That translates into safe and inexpensive illumination systems. A film detection system may also be inexpensive. The user could incur costs to develop the film and use a color scanner to get the data into the computer for processing into 3D surface data.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein. For example, an illumination source may be a laser, laser diode, light emitting diode, flashlight, halogen, fluorescent or incandescent bulb, etc. which may or may not be filtered by a color transparency, or reflected off an object with variations in reflectivity across it's surface, or combined with holographic materials for diffracting the light sources into the desired patterns of light. Likewise, image sensors may be any kind of CCD, camera, film, scanner etc. which image through pinholes, or using reflective or transmissive lenses or reflective or transmissive diffractive optics. And processor may be used synonymously with a computer, computing device, or other intelligent means of processing data. Additionally, the surface may be any interface that can receive light from the illumination sources and return light to the imaging sensors. Thus, a translucent membrane with liquids on either side could act as a surface that could be acquired. The optical perspective of a source or sensor may be synonymous with the direction of it's view or field of view.

The invention claimed is:

1. An optical system for acquiring topography of a surface of an object comprising:
one or more illumination sources emitting patterns of light onto the surface of the object, each of the illumination sources being configured with the same optical perspective;
one or more image sensors which image the surface of the object from one optical perspective which is different from the optical perspective of the illumination sources; and
a processor coupled to the illumination sources and the imaging sensors;
wherein the illumination sources and the imaging sensors are separated along a known direction by a known distance so as to have different perspective views of the surface;
wherein the imaging sensors captures light from the emitted patterns reflected from the surface of the object and converts the captured light into patterned image data;
wherein the emitted patterns of light are coded in such a way such that the processor can identify the path the light traveled from the illumination sources to the surface of the object; and
wherein the processor receives the patterned image data from the imaging sensors and computes the surface topography based upon the patterned image data, the known separation between the illumination sources and the imaging sensors, and knowledge about how the patterns of light are projected from the illumination sources.

2. The system of claim 1, wherein the pattern of light is an array of planes of light which creates a projection of lines on the surface of the object;
wherein the displacement direction between the illumination sources and the imaging sensors is in any direction other than a direction tangent to any portion of the projected lines on the surface; and
wherein the processor is able to measure the distortion of the projected lines on the surface of the object due to viewing them from an optical perspective which is different from the optical perspective of the illumination sources.

3. The system of claim 2, wherein the lines are similar along their length but vary from one to the next in color or composition of different wavelengths;
wherein the imaging sensors are able to detect the different colors or composition of different wavelengths.

4. The system of claim 2, wherein the lines are similar along their length but vary from one to the next in intensity;
wherein the imaging sensors are able to detect the different intensities.

5. The system of claim 2, wherein the lines are similar along their length but vary from one to the next in polarization;
wherein the imaging sensors and processor are able to identify the different polarizations.

6. The system of claim 2, further comprising:
a white light illumination source directed at the colored surface of the object to reflect colored light from the colored surface of the object into the imaging sensors;
wherein the white light illumination source is directed along the same optical perspective as other illumination sources;
wherein the imaging sensors capture a colored image of the white light illuminated colored surface of the object; and
wherein the processor receives the colored image data from the imaging sensors and utilizes the colored image data in mapping the colored image onto the surface topography.

7. The system of claim 2, further comprising:
a white light illumination source directed at the colored surface of the object to reflect colored light from the colored surface of the object into the imaging sensors;
wherein the white light illumination source is directed along the same optical perspective as other illumination sources;
wherein the imaging sensors capture a colored image of the white light illuminated colored surface of the object;
wherein the processor receives the colored image data and utilizes the colored image data to deduce the transmission of colors to each portion of the image; and
wherein the information about transmission of colors is used to alter the intensity and color of portions of the pattern of light projected by the illumination sources in order to improve the quality of information that will be obtained in the subsequent capture of patterned image data.

8. The system of claim 2, wherein each of the lines is uniquely identifiable by some quality, and the transition of that quality from a first value to the last value forms a continuous path which resultantly allows for application of numerical techniques to obtain sub-pixel accuracy in the location of a specific quality on the image sensor.

9. The system of claim 1, further comprising:
capability of the illumination sources to project a rapid succession of different patterns of light; and
multiple image acquisition capability in the imaging sensors selected from group comprising gating of multiple imaging sensors and sequential image captures by one imaging sensor;
wherein a pixel from each image is combined to provide a coding scheme which allows the processor to determine the path taken by the light reaching that pixel.

10. An optical method for acquiring topography of a surface of an object comprising the steps of:
illuminating the surface of the object with patterns of light from illumination sources which projects light from one optical perspective;
capturing patterned light from the illumination sources reflected from the surface of the object with image sensors that have one optical perspective which is different from the optical perspective of the illumination sources;
converting the captured light patterns into patterned image data; and
computing the surface topography based upon the patterned image data, the known separation between the illumination sources and the imaging sensors, and knowledge about how the patterns of light are projected from the illumination sources.

11. The method of claim 10, wherein the pattern of light is an array of planes of light which creates a projection of lines on the surface of the object;
wherein the displacement direction between the illumination sources and the imaging sensors is in any direction other than a direction tangent to any portion of the projected lines on the surface; and
wherein the processor is able to measure the distortion of the projected lines on the surface of the object due to viewing them from an optical perspective which is different from the optical perspective of the illumination sources.

12. The method of claim 11, wherein the lines are similar along their length but vary from one to the next in color or composition of different wavelengths; and
wherein the imaging sensors are able to detect the different colors or composition of different wavelengths.

13. The method of claim 11, wherein the lines are similar along their length but vary from one to the next in intensity; and
wherein the imaging sensors are able to detect the different intensities.

14. The method of claim 11, wherein the lines are similar along their length but vary from one to the next in polarization; and
wherein the imaging sensors and processor are able to identify the different polarizations.

15. The method of claim 11, further comprising the steps of:
illuminating the surface of the object with white light from illumination sources;
capturing reflected colored light from the colored surface of the object;
converting the reflected colored light image to colored light image data; and
computing the colored light data wherein the computing step utilizes the colored light data to map the color image onto the surface topography;
wherein the white light illumination source is directed along the same optical perspective as other illumination sources;

16. The method of claim 11, further comprising steps of:
illuminating the surface of the object with white light from illumination sources;
capturing reflected colored light from the colored surface of the object;
converting the reflected colored light image to colored light image data;
computing the transmission of colors to each pixel of the imaging sensor;
altering the intensity and color of portions of the pattern of light projected by the illumination sources in order to improve the quality of information that will be obtained in the subsequent capture of patterned image data;
illuminating the surface of the object with the altered patterns of light from the illumination sources; and
capturing the image from the reflection of the newly altered patterns of light from the surface of the object;
converting the captured light patterns into patterned image data; and
computing the surface topography based upon the patterned image data, the known separation between the illumination sources and the imaging sensors, and knowledge about how the patterns of light are projected from the illumination sources;
wherein the white light illumination source is directed along the same optical perspective as other illumination sources;

17. The method of claim 11, wherein each of the lines is uniquely identifiable by some quality, and the transition of that quality from a first value to the last value forms a continuous path which resultantly allows for application of numerical techniques to obtain sub-pixel accuracy in the location of a specific quality on the image sensor.

18. The method of claim 10, further comprising the steps of:
capturing a series of images, each of a different pattern of light projected on the surface of the object by illumination sources;
converting the captured light patterns into patterned image data; and
computing the surface topography based upon the combination of patterned image data, the known separation between the illumination sources and the imaging sensors, and knowledge about how the patterns of light are projected from the illumination sources.
